(19) United States
(12) Patent Application Publication
(10) Pub. No.: US 2012/0251859 A1
(43) Pub. Date: Oct. 4, 2012

(54) BATTERY PACK HAVING LIQUID LEAK DETECTION SYSTEM

(75) Inventors: Josh Payne, Royal Oak, MI (US); Vaughan Daniel, Ann Arbor, MI (US)

(73) Assignee: LG CHEM, LTD., Seoul (KR)

(21) Appl. No.: 13/076,774

(22) Filed: Mar. 31, 2011

(51) Int. Cl. H01M 10/42; G01M 3/40; B23P 11/00

(52) U.S. Cl. 429/90; 29/428; 702/51

(57) ABSTRACT

A battery pack and a liquid leak detection system are provided. The system includes first and second wire grids and an open-cell foam layer. The first and second wire grids are disposed on first and second sides, respectively, of the foam layer. The foam layer allows at least a portion of liquid contacting the foam layer to migrate from the first side to the second side. The system further includes an insulating mat disposed between the second wire grid and a tray. The system further includes a resistance measuring device that outputs a first signal indicative of a resistance level between the wire grids. The system further includes a microprocessor that compares an amplitude of the first signal to a threshold value, and outputs a second signal if the liquid is detected based on the comparison.

### BACKGROUND

Battery packs have been developed that receive a liquid for cooling the battery packs. The inventor herein has recognized that it would be desirable to detect liquid leaking from the battery pack if such a leak occurs.

### SUMMARY

A battery pack in accordance with an exemplary embodiment is provided. The battery pack includes at least one battery module configured to receive a liquid therein for cooling the battery module. The battery pack further includes a liquid leak detection system disposed adjacent to the at least one battery module. The liquid leak detection system includes first and second electrically conductive wire grids, and an open-cell foam layer having a first side and a second side. The first electrically conductive wire grid is disposed on the first side, and the second electrically conductive wire grid is disposed on the second side. The open-cell foam layer has a predetermined thickness to allow at least a portion of the liquid contacting the open-cell foam layer to migrate from the first side to the second side. The liquid leak detection system further includes an insulating mat disposed between the second electrically conductive wire grid and a tray. The tray is configured to hold the insulating mat, the open-cell foam layer, and the first and second electrically conductive wire grids therein. The liquid leak detection system further includes a resistance measuring device configured to output a first signal indicative of a resistance level between the first and second electrically conductive wire grids. The liquid leak detection system further includes a microprocessor configured to compare an amplitude of the first signal to a threshold value. The microprocessor is further configured to output a second signal if the comparison of the amplitude of the first signal and the threshold value indicates that the liquid is detected.

A liquid leak detection system in accordance with another exemplary embodiment is provided. The liquid leak detection system includes first and second electrically conductive wire grids. The liquid leak detection system further includes an open-cell foam layer having a first side and a second side. The first electrically conductive wire grid disposed on the first side, and the second electrically conductive wire grid is disposed on the second side. The open-cell foam layer has a predetermined thickness to allow at least a portion of liquid contacting the open-cell foam layer to migrate from the first side to the second side. The liquid leak detection system further includes an insulating mat disposed between the second electrically conductive wire grid and a tray. The tray is configured to hold the insulating mat, the open-cell foam layer, and the first and second electrically conductive wire grids therein. The liquid leak detection system further includes a resistance measuring device configured to output a first signal indicative of a resistance level between the first and second electrically conductive wire grids. The liquid leak detection system further includes a microprocessor configured to compare an amplitude of the first signal to a threshold value. The microprocessor is further configured to output a second signal if the comparison of the amplitude of the first signal and the threshold value indicates that the liquid is detected.

A method for manufacturing a battery pack in accordance with another exemplary embodiment is provided. The method includes disposing an insulating mat in a tray. The method further includes disposing a first electrically conductive wire grid on the insulating mat. The method further includes disposing an open-cell foam layer on the first electrically conductive wire grid. The method further includes disposing a second electrically conductive wire grid on the open-cell foam layer. The open-cell foam layer has a predetermined thickness to allow at least a portion of a liquid contacting the open-cell foam layer to migrate from the first side to the second side. The method further includes coupling the first and second electrically conductive wire grids to a resistance measuring device configured to output a first signal indicative of a resistance level between the first and second electrically conductive wire grids. The method further includes disposing at least one battery module on the first electrically conductive wire grid. The at least one battery module is configured to receive liquid therein for cooling the battery module.

### BRIEF DESCRIPTION OF THE DRAWINGS

FIG. 1 is a schematic of a battery pack in accordance with an exemplary embodiment;

FIG. 2 is a schematic of a liquid leak detection system utilized in the battery pack of FIG. 1 in accordance with another exemplary embodiment;

FIG. 3 is an exploded view of the liquid leak detection system of FIG. 2;

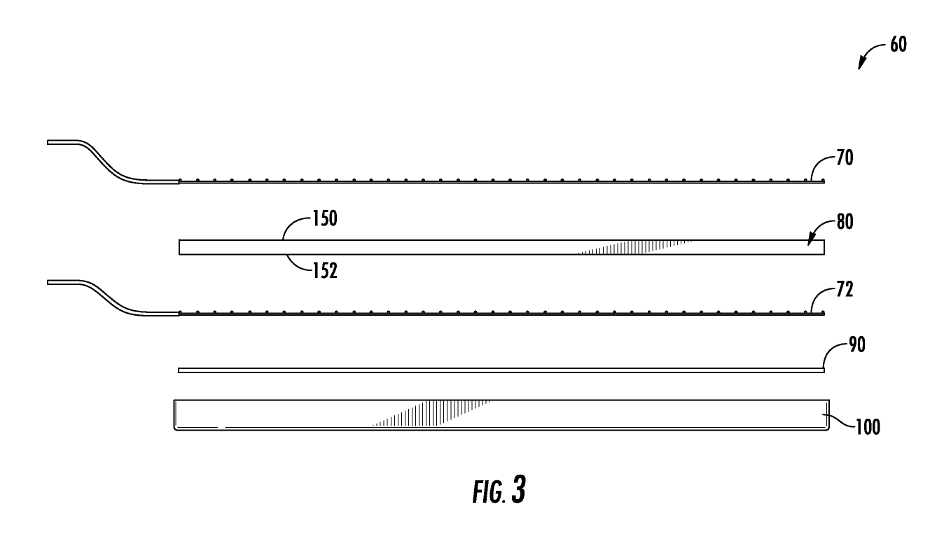

FIG. 4 is a flowchart of a method for detecting a liquid utilizing the liquid leak detection system of FIG. 2 in accordance with another exemplary embodiment;

FIG. 5 is a flowchart of a method for manufacturing the battery pack of FIG. 1 in accordance with another exemplary embodiment; and

FIG. 6 is a cross-sectional schematic of a portion of the leak detection system of FIG. 1.

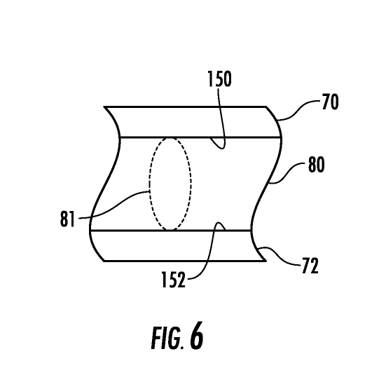

### DETAILED DESCRIPTION

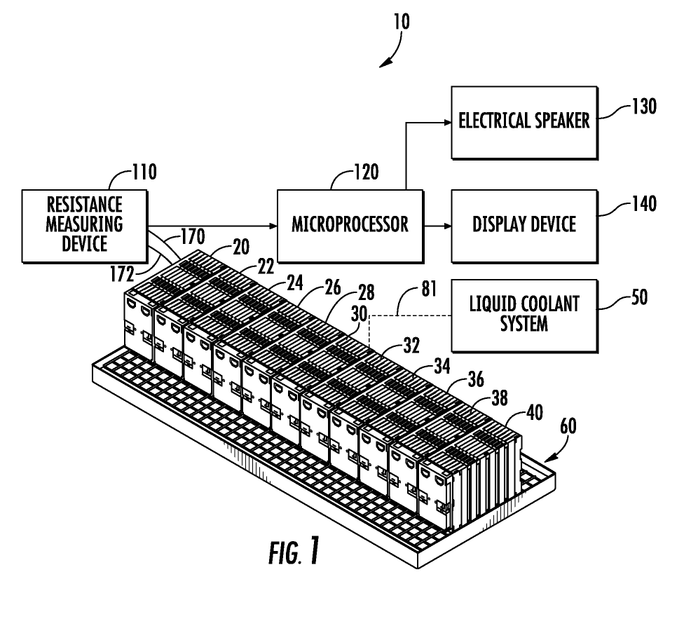

Referring to FIG. 1, a battery pack 10 having a liquid detection system 60 in accordance with an exemplary embodiment is provided. The battery pack 10 includes battery modules 20, 22, 24, 26, 28, 30, 32, 34, 36, 38, 40, a liquid coolant system 50, and the liquid detection system 60.

The liquid coolant system 50 is configured to provide a liquid 81 to the battery modules 20-40 for cooling the battery modules 20-40.

The liquid leak detection system 60 is configured to detect when a portion of the liquid 81 has leaked from the battery modules 20-40. The liquid detection system 60 includes electrically conductive wire grids 70, 72, an open cell foam layer 80, an insulating mat 90, a tray 100, a resistance measuring device 110, a microprocessor 120, an electrical speaker 130, and a display device 190.

The electrically conductive wire grid 70 has a generally rectangular shape and is constructed of an electrically conductive material. In one exemplary embodiment, the electrically conductive wire grid 70 is constructed of copper. Of course, in alternative embodiments, the electrically conductive wire grid 70 could be constructed of other metals or metal alloys known to those skilled in the art. Also, in alternative embodiments, the shape of the electrically conductive wire grid 70 could vary based upon a desired application. As shown, the battery modules 20-40 are disposed on a top portion of the electrically conductive wire grid 70.

The open-cell foam layer 80 is disposed between the electrically conductive wire grids 70, 72. The open-cell foam layer 80 has a first side 150 and a second side 152. The electrically conductive wire grid 70 is disposed on the first side 150, and the electrically conductive wire grid 72 is disposed on the second side 152. The open-cell foam layer 80 has a predetermined thickness to allow at least a portion of the liquid 81 contacting the open-cell foam layer 80 to migrate from the first side 150 to the second side 152. Also, the open cell foam layer 80 has a rectangular shape and defines an area substantially equal to an area of each of the electrically conductive wire grids 70, 72.

The electrically conductive wire grid 72 has a generally rectangular shape and is constructed of an electrically conductive material. In one exemplary embodiment, the electrically conductive wire grid 72 is constructed of copper. Of course, in alternative embodiments, the electrically conductive wire grid 72 could be constructed of other metals or metal alloys known to those skilled in the art. Also, in alternative embodiments, the shape of the electrically conductive wire grid 72 could vary based upon a desired application. As shown, the electrically conductive wire grid 72 is disposed between the open-cell foam layer 80 and the insulating mat 90.

The insulating mat 90 is disposed between the electrically conductive wire grid 72 and the tray 100. In one exemplary embodiment, the insulating mat 90 is constructed of a rubber compound. Of course, in an alternative embodiment, the insulating mat 90 could be constructed of other non-electrically conductive materials known to those skilled in the art.

The tray 100 is configured to hold the insulating mat 90, the open-cell foam layer 80, and the electrically conductive wire grids 70, 72 therein. The tray 100 has side walls 160, 161, 162, 163 coupled to a base plate 164. A height of each of the side walls 160, 161, 162, 163 is at least equal to or greater than a height of a stacked assembly of the insulating matt 90, the open-cell foam layer 80, and the electrically conductive wire grids 70, 72. In one exemplary embodiment, the tray 100 is constructed of plastic.

The resistance measuring device 110 is electrically coupled to the electrically conductive wire grids 70, 72 utilizing the electrical conductors 170, 172, respectively. The resistance measuring device 110 is configured to output a first signal indicative of a resistance level between the electrically conductive wire grids 170, 172. When at least a predetermined amount of liquid 81 flows through apertures in the electrically conductive wire grid 70, the liquid 81 propagates through the open-cell foam layer 80 to the electrically conductive wire grid 72 and forms a conductive path between the grids 70, 72. Thus, when the liquid 81 flows through apertures in the electrically conductive wire grid 70 and propagates through the open-cell foam layer 80 to the electrically conductive wire grid 72, a resistance level between the grids 70, 72 is reduced to a resistance level less than or equal to a threshold resistance value. Otherwise, when the open-cell foam layer is dry, a resistance level between the grids 70, 72 is greater than the threshold resistance value. The threshold resistance value is an empirically determined value. In one exemplary embodiment, however, the threshold resistance value could be in a range of 1-1000 Ohms for example.

The microprocessor 120 is operably coupled to the resistance measuring device 110, an electrical speaker 130, and a display device 140. The microprocessor 120 monitors an output signal from the resistance measuring device 110 to detect a liquid 81 as will be explained in greater detail below.

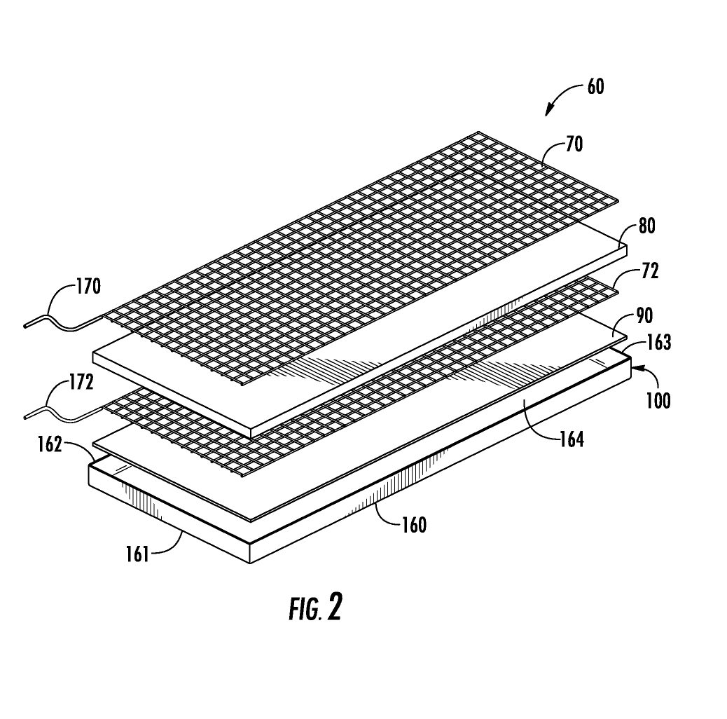

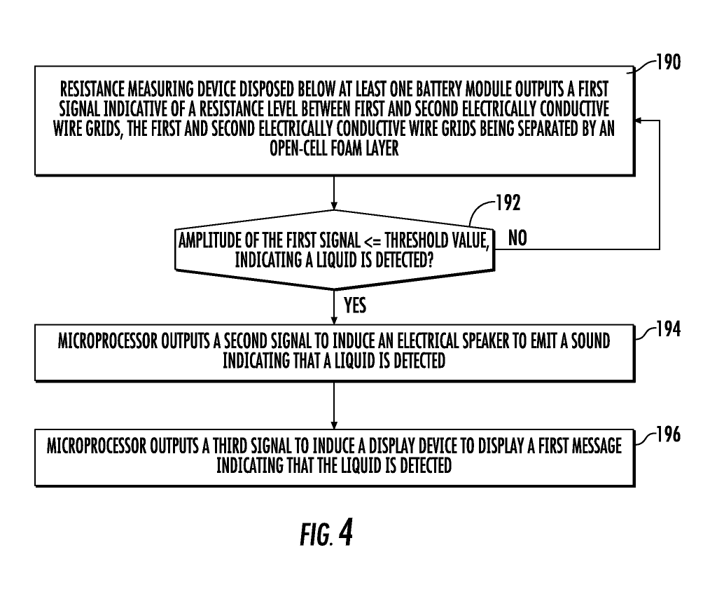

Referring to FIGS. 1, 2 and 4, a flowchart of a method for detecting a liquid 81 leaking from a battery module in accordance with another exemplary embodiment will now be explained.

At step 190, the resistance measuring device 110 that is disposed below at least one battery module outputs a first signal indicative of a resistance level between electrically conductive wire grids 70, 72. The electrically conductive wire grids 70, 72 are separated by the open-cell foam layer 80.

At step 192, the microprocessor 120 makes a determination as to whether an amplitude of the first signal is less than or equal to a threshold value, indicating a liquid 81 is detected. If the value of step 192 equals “yes”, the method advances to step 194. Otherwise, the method returns to step 190.

At step 194, the microprocessor 120 outputs a second signal to induce the electrical speaker 130 to emit a sound indicating that a liquid 81 is detected.

At step 196, the microprocessor 120 outputs a third signal to induce the display device 140 to display a first message indicating that the liquid 81 is detected.

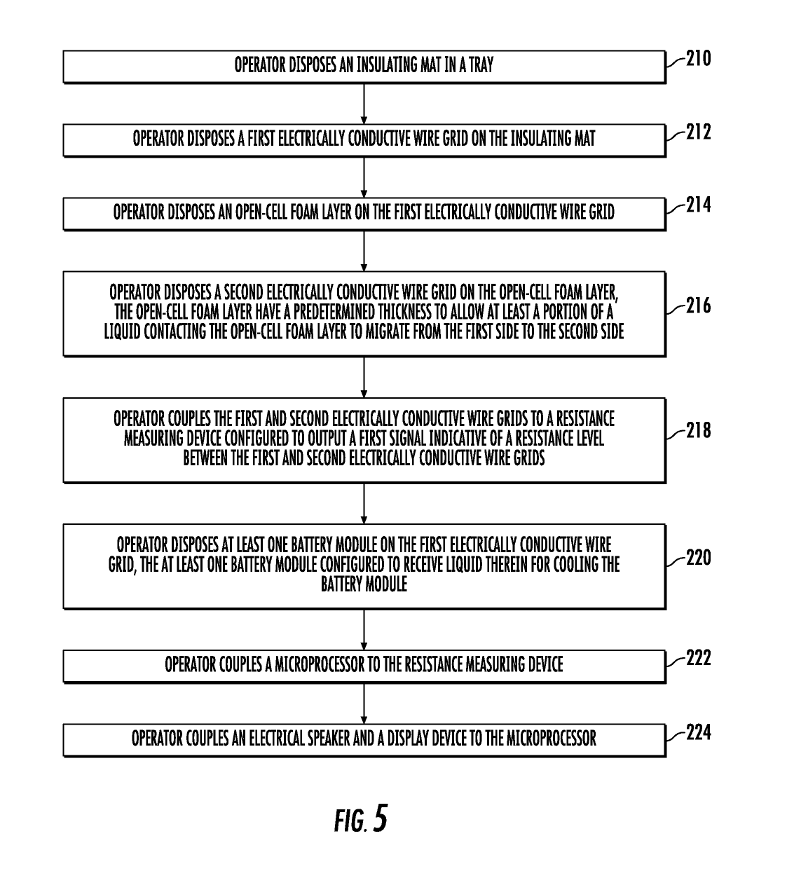

Referring to FIGS. 1, 2 and 5, a flowchart of a method for manufacturing the battery pack 10 in accordance with another exemplary embodiment will now be explained.

At step 210, an operator disposes the insulating mat 90 in the tray 100.

At step 212, the operator disposes the electrically conductive wire grid 72 on the insulating mat 90.

At step 214, the operator disposes the open-cell foam layer 80 on the electrically conductive wire grid 72.

At step 216, the operator disposes the electrically conductive wire grid 70 on the open-cell foam layer 80. The open-cell foam layer 80 has a predetermined thickness to allow at least a portion of the liquid 81 contacting the open-cell foam layer 80 to migrate from the first side 150 to the second side 152.

At step 218, the operator couples the electrically conductive wire grids 70, 72 to the resistance measuring device 110 which is configured to output a first signal indicative of a resistance level between the electrically conductive wire grids 70, 72.

At step 220, the operator disposes at least one battery module on the electrically conductive wire grid 70. The at least one battery module is configured to receive liquid 81 therein for cooling the battery module.

At step 222, the operator couples the microprocessor 120 to the resistance measuring device 110.

At step 224, the operator couples the electrical speaker 130 and the display device 140 to the microprocessor 120.

The battery pack 10 and the liquid detection system 60 provide a substantial advantage over other battery packs and liquid detection systems. In particular, the liquid detection system 60 provides a technical effect of detecting liquid leaking from a battery module utilizing a pair of electrically conductive wire grids separated by an open-cell foam layer.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

We claim:

1. A battery pack, comprising:
at least one battery module configured to receive a liquid therein for cooling the battery module; and
a liquid leak detection system disposed adjacent to the at least one battery module, the liquid leak detection system comprising:
first and second electrically conductive wire grids;
an open-cell foam layer having a first side and a second side, the first electrically conductive wire grid disposed on the first side, the second electrically conductive wire grid disposed on the second side, the open-cell foam layer has a predetermined thickness to allow at least a portion of the liquid contacting the open-cell foam layer to migrate from the first side to the second side;
an insulating mat disposed between the second electrically conductive wire grid and a tray, the tray being configured to hold the insulating mat, the open-cell foam layer, and the first and second electrically conductive wire grids therein;
a resistance measuring device configured to output a first signal indicative of a resistance level between the first and second electrically conductive wire grids; and
a microprocessor configured to compare an amplitude of the first signal to a threshold value, the microprocessor further configured to output a second signal if the comparison of the amplitude of the first signal and the threshold value indicates that the liquid is detected.

2. The battery pack of claim 1, wherein the comparison of the amplitude of the first signal and the threshold value indicates that the liquid is detected if the amplitude of the first signal is less than or equal to the threshold value.

3. The battery pack of claim 1, wherein the liquid leak detection system further comprises an electrical speaker configured to emit a sound indicating that the liquid is detected in response to receiving the second signal.

4. The battery pack of claim 1, wherein the microprocessor of the liquid leak detection system is further configured to induce a display device to display a first message indicating that the liquid is detected if the comparison of the amplitude of the first signal and the threshold value indicates that the liquid is detected.

5. The battery pack of claim 1, wherein the open-cell foam layer is an open-cell polyurethane foam layer.

6. A liquid leak detection system, comprising:
first and second electrically conductive wire grids;
an open-cell foam layer having a first side and a second side, the first electrically conductive wire grid disposed on the first side, the second electrically conductive wire grid disposed on the second side, the open-cell foam layer has a predetermined thickness to allow at least a portion of liquid contacting the open-cell foam layer to migrate from the first side to the second side;
an insulating mat disposed between the second electrically conductive wire grid and a tray, the tray being configured to hold the insulating mat, the open-cell foam layer, and the first and second electrically conductive wire grids therein;
a resistance measuring device configured to output a first signal indicative of a resistance level between the first and second electrically conductive wire grids; and
a microprocessor configured to compare an amplitude of the first signal to a threshold value, the microprocessor further configured to output a second signal if the comparison of the amplitude of the first signal and the threshold value indicates that the liquid is detected.

7. The liquid leak detection system of claim 6, wherein the comparison of the amplitude of the first signal and the threshold value indicates that the liquid is detected if the amplitude of the first signal is less than or equal to the threshold value.

8. The liquid leak detection system of claim 6, further comprising an electrical speaker configured to emit a sound indicating that the liquid is detected in response to receiving the second signal.

9. The liquid leak detection system of claim 6, wherein the microprocessor is further configured to induce a display device to display a first message indicating that the liquid is detected if the comparison of the amplitude of the first signal and the threshold value indicates that the liquid is detected.

10. The liquid leak detection system of claim 6, wherein the open-cell foam layer is an open-cell polyurethane foam layer.

11. A method for manufacturing a battery pack, comprising:
disposing an insulating mat in a tray;
disposing a first electrically conductive wire grid on the insulating mat;
disposing an open-cell foam layer on the first electrically conductive wire grid;
disposing a second electrically conductive wire grid on the open-cell foam layer, the open-cell foam layer has a predetermined thickness to allow at least a portion of a liquid contacting the open-cell foam layer to migrate from the first side to the second side;
coupling the first and second electrically conductive wire grids to a resistance measuring device configured to output a first signal indicative of a resistance level between the first and second electrically conductive wire grids; and
disposing at least one battery module on the first electrically conductive wire grid, the at least one battery module configured to receive liquid therein for cooling the battery module.

12. The method of claim 11, further comprising coupling a microprocessor to the resistance measuring device.
